(19) United States
(12) Patent Application Publication
(10) Pub. No.: US 2005/0107106 A1
(43) Pub. Date: May 19, 2005

(54) Method and network element for controlling power and/or load in a network

(76) Inventors: Kimmo Valkealahti, Helsinki (FI); Albert Hoglund, Helsinki (FI); Ari Hamalainen, Vantaa (FI); Janne Laakso, Helsinki (FI); Antti Sorvari, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/503,383

(22) PCT Filed: Feb. 25, 2002
(86) PCT No.: PCT/IB02/00571

(51) Int. Cl. H04B 7/00

(52) U.S. Cl. 455/522; 455/69

(57) ABSTRACT

The present invention relates to a method and network element for controling power and/or load in a network, wherein a reference table is stored and used for deriving a reference control value from at least one connection-specific parameter. The power and/or load control is then performed based on the derived reference control value. The reference control values stored in the reference table are estimated based on a real measurement of at least one predetermined network parameter, and the reference table is updated using the estimated reference control values. Thereby, an autotuning mechanism is provided to adjust the reference control values based on real measurements, so that real location-dependent radio propagation conditions are taken into account.

### FIELD OF THE INVENTION

The present invention relates to a system and network element for controlling power and/or load in a data or communication network, such as a cellular radio access network (RAN).

### BACKGROUND OF THE INVENTION

Power control is one of the most important requirements for cellular network systems, such as the Universal Mobile Telecommunications System (UMTS). Adequate power control means that power control steps and power control dynamic variations due to fast fading are averaged or neglected. To achieve this, power control usually follows an iterative algorithm, which increases or decreases the transmission power of a mobile terminal or traffic channel until an error criteria is minimized. This error can be e.g. the difference between a target Eb/No and an achieved Eb/No, wherein the parameter Eb/No indicates the level of received bit energy to interference density. The target or reference Eb/No indicates the Eb/No, which the receiver equipment requires for proper decoding of the signal.

The overall transmitted power assigned to a base station in the cellular network is split among a pilot channel, a synchronization channel, paging channels and traffic channels. The pilot signal strength is set to a fixed percentage of the maximum transmitted power. The paging signal strength and the synchronization signal strength are constant, too. The remaining transmission power not reserved to the above mentioned control channels is then available for traffic channels. A nominal transmission power level is defined for every traffic channel, wherein the effective transmission power can be arranged or controlled by means of a power control function, while not exceeding a given range.

In the UMTS specifications, power control is composed of an inner loop control, wherein power control is performed based on a comparison of a signal-to-interference ratio (SIR) measurement and an SIR target value, and an outer loop control, wherein the SIR target value is updated based on e.g. block error rate (BLER) measurements.

When the network operates in a macro diversity mode, the mobile terminal may be connected simultaneously to several base stations belonging to its active set. The active set is usually composed of base stations having parameters (e.g. path loss, Ec/lo, etc.) within a handover margin, as they identify the best base station parameters received by the corresponding mobile terminal. In dynamic situations, a base station may be entered to a candidate set which identifies suitable base stations for soft handover possibly not included in the active set, if the parameter ratio measured at the mobile station exceeds a predetermined threshold value for addition. On the other hand, a base station which is currently in the candidate set may be removed if its ratio falls below another threshold value for dropping.

In the downlink direction, macro diversity is achieved by transmitting the downlink signal from several base stations to the mobile terminal. Then, power control is performed on the bases of the SIR which results after combining the signal coming from all active links. In the uplink direction, diversity combining is applied at a radio network controller (RNC) serving the concerned mobile terminal. In this case, the quality is evaluated for each link arriving at the RNC separately and the best link is chosen. Power adjustment commands are set by each partying base station separately.

The use of admission control schemes which constrain the base station to keep its operating point within a certain range of power is a necessary requirement in cellular networks, such as the UMTS or Wideband Code Division Multiple Access (WCDMA) network. Whilst this reduces the overall capacity of the network, it does ensure that base stations never actually “crash” and that the network does not become unstable due to excessive interaction between cells. Examples for load control algorithms can be found in J. Knutsson et al, “Evaluation of Admission Control Algorithms for CDMA Systems in a Manhattan Environment”, in proc 2nd CDMA International Conference, Seoul, 1997.

If the traffic is too high, the network might become instable. In 3rd generation cellular systems, an increase of non real time (NRT) data transmission is foreseen. Particularly, a great increase of Internet services is expected, which will have a main impact on downlink transmissions.

As already mentioned, the reference Eb/No is the level of the received bit energy to the interference density that a receiver equipment requires for proper decoding of the received signal. A radio resource management (RRM) unit provided in the RNC needs to know the levels of reference Eb/Nos for optimal resource allocation. For instance, the downlink reference Eb/Nos are needed in estimation of downlink power changes with changing services and bit rates, scaling of maximum link power from that of the reference service, determination of initial downlink power, scaling of the power of the Downlink Shared Channel from that of the associated Dedicated Channel, and static rate matching. The downlink reference Eb/No depends on the service (e.g. speech, circuit-switched data, packet-switched data), coding, bit rate, terminal speed, degree of multipath diversity, and burstiness of the interference at the terminal device. Therefore, Eb/No tables each specific to a base station sector are stored at the RNC to indicate the reference Eb/No for each service and bit rate. The reference values stored in the Eb/No table are obtained from simulations e.g. from system supplier's link level simulations. In conventional systems, the reference values of the Eb/No table have been set during the network planning phase and maintained manually during network operation. However, this does not provide optimum results, because the Eb/No reference values heavily depend on the radio environment which is unique for each location of a terminal device. Moreover, the manual setting of the reference values is hard and laborious and may not produce optimal values.

Hence, in conventional systems, it is difficult and time-consuming to determine the correct reference values for a particular cell. If the reference values are selected manually e.g. by the network operator, the corresponding radio network planning personnel must be very experienced and still the right selection will be more or less based on trial and error.

If the Eb/No reference values are not correct, the initial SIR target value and rate matching attributes as well as the uplink power increase estimation and selected power values for the NRT traffic may be wrong. This results in an incorrect estimation of capacity and coverage of the network.

### SUMMARY OF THE INVENTION

It is therefore an object of the present invention to provide a method and network element for controlling power and/or load in a network, by means of which the selection of reference control values can be optimised.

This object is achieved by a method of controlling power and/or load in a network said method comprising the steps of:
storing a reference table in the network;
using the reference table for deriving a reference control value from at least one connection-specific parameter;
performing the power and/or load control based on the reference control value;
estimating reference control values for the reference table based on a real measurement of at least one predetermined network parameter; and
updating the reference table using the estimated reference control values.

Additionally, the above object is achieved by a network element for controlling power and/or load in a network, the network element comprising:
storing means for storing a reference table used for deriving a reference control value from at least one connection-specific parameter;
control means for performing the power and/or load control based on the reference control value;
estimating means for estimating reference control values for the reference table based on a real measurement of at least one predetermined network parameter; and
   updating means for updating the reference table using the estimated reference control values.

Accordingly, an autotuning solution is provided by means of which the reference control values in the reference table are adjusted based on real measurements. Thereby, real location-dependent transmission or radio propagation conditions can be taken into account. The reference control values may be-used in uplink admission control, load control, packet scheduling based on a estimation of uplink power increase and other implementation examples as initially mentioned. The reference control values may as well be used as initial SIR target values in uplink outer loop power control and for determining rate matching attributes.

As regards quality of service, the use of correct or optimised reference control values will prevent overload situations where the quality and/or bit rate of some of the users has to be decreased or even some of them have to be dropped from the network.

The autotuning mechanism provides the advantage of an improved operability as the right performance is achieved in a fast manner with very small personal requirements or even without any human interaction, when the autotuning algorithm is used in a fully automatic mode. Thus, the suggested autotuning mechanism leads to an increased operability and handling of radio resource management (RRM) and radio network planning (RNP).

Preferably, the reference control value may indicate a level of received bit energy to interference density which a receiver equipment requires for proper decoding of a received signal.

Furthermore, the real measurement may comprise an outer loop power control measurement.

The at least one connection-specific parameter may comprise a bit rate and/or a target block error rate of the connection.

The reference table may be used for an uplink transmission, wherein the estimation step comprises the steps of selecting a connection, collecting outer loop power control statistics of the connection, and filtering the collected statistics. The estimation step may further comprise the step of collecting samples of the filtered statistics which may comprise SIR values. The collected statistics may then be averaged in the filtering step. The reference control value may be estimated per antenna or by combining reference control values over a plurality of antennas. The reference table may be a cell based table.

The at least one estimated reference value may be transmitted to a network management function for deciding whether or not to update the reference table. In this case, the transmission and decision may be performed in response to the value of a predetermined parameter. The decision step may be performed for all reference control values relating to the corresponding connection-specific parameter.

As an alternative, the estimation step may be performed at a network management function.

The outer loop power control statistics may be collected from connections having a single radio access bearer per connection.

Furthermore, the collecting step may be performed by collecting new samples as long as the total number of connections for a certain one of the at least one predetermined network parameters is below a predetermined threshold.

Additionally, a forgetting factor may be used in the filtering step, the forgetting factor defining scalar weights applied to the estimated reference control values. The forgetting factor may be adjusted to change the speed of the updating step. Only the last filtered value may be stored for use in a subsequent filter operation.

The table update may be performed when the at least one predetermined network parameter has changed by a value higher than a predetermined threshold value.

Alternatively, the filtering step may be performed by using a sliding window filter operation. Then, a parameter may be provided for switching between the sliding window filter operation and the filter operation based on the forgetting factor.

Furthermore, a parameter may be provided for defining whether or not soft handover connections are used in the updating step.

Additionally, upper and/or lower limit values may be provided for the updating step. In this case, an indication function may be activated if the upper or lower limit value is reached during the updating step.

The updating step may be inhibited based on the result of a hypothesis testing.

According to another advantageous further development, a corresponding reference table may be used for a downlink transmission, wherein the estimation step may comprise the steps selecting a downlink transmission link, and calculating an estimation of the reference control value based on a predetermined equation depending on the processing gain, the transmission power to the corresponding terminal, the path loss between the transmitter and the terminal, and the interference. The selection and calculation step may be performed periodically through at least a subset of all downlink transmission links in a predetermined sector. A filtering step may as well be provided based on the forgetting factor for performing an adaptation towards the estimated reference control values.

As an alternative, for the case of a reference table used for a downlink transmission, the estimation step may be performed based on retransmission rate of a corresponding service.

As another alternative for the case of the reference table used for a downlink transmission, the estimating step may be performed based on an uplink reference control value received from the corresponding terminal device.

The network element may comprise a filtering means for applying the filter operation to the estimated reference control values. Furthermore, the network element may be a radio network controller or may comprise a network management system.

### BRIEF DESCRIPTION OF THE DRAWINGS

In the following, the present Invention will be described in greater detail based on preferred embodiments with reference to the accompanying drawings, in which:

FIG. 1 shows a schematic block diagram of an uplink transmission system according to a first preferred embodiment of the present invention;

FIG. 2 shows a basic flow diagram of a table updating operation according to the first preferred embodiment;

FIG. 3 shows an algorithm as an example for collecting new samples in the table updating operation according to the first preferred embodiment;

FIG. 4 shows an algorithm as an example for a threshold based updating algorithm according to the first preferred embodiment;

FIG. 5 shows a schematic block diagram of a downlink transmission system according to a second preferred embodiment; and

FIG. 6 shows a basic flow diagram of a table updating operation according to the second preferred embodiment.

### DESCRIPTION OF THE PREFERRED EMBODIMENTS

The preferred embodiments will now be described on the basis of an autotuning mechanism provided in a WCDMA radio connection of a radio access network.

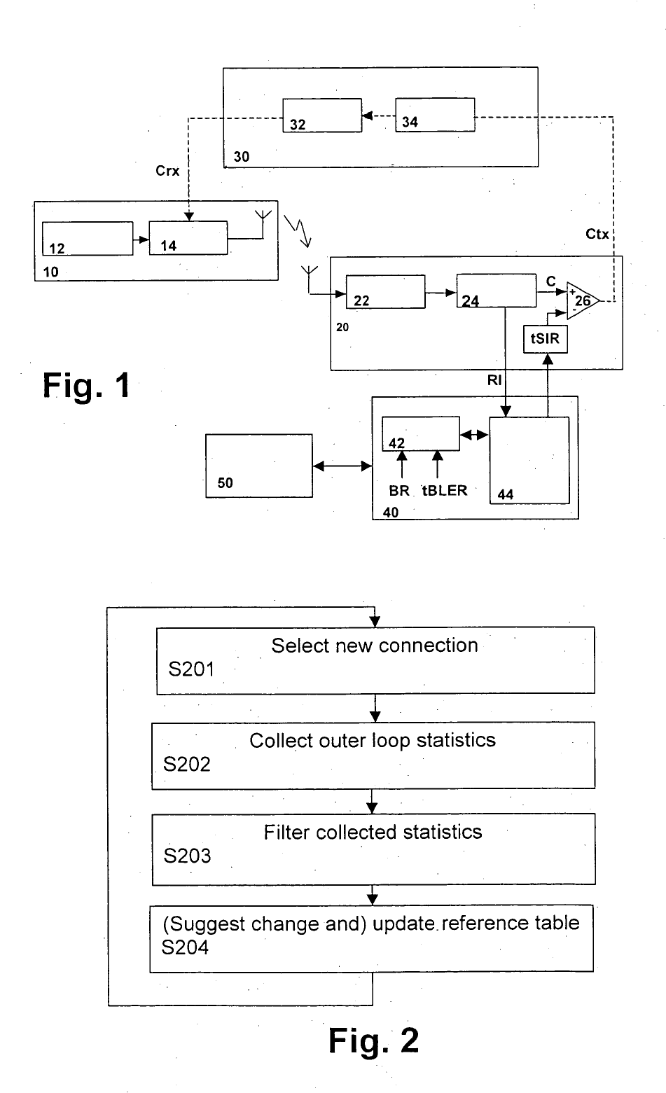

FIG. 1 shows a schematic block diagram of a transmission system according to the first preferred embodiment, wherein a terminal device 10, e.g. a mobile terminal or a user equipment, is connected by a radio transmission link to a node B or base station 20. In the mobile terminal 10, a WCDMA transmitter 12 is provided for generating a corresponding transmission signal to be supplied to a power amplifier 14 in which the transmission power is adjusted based on a received power command Crx, e.g. “up” or “down”, received via a return channel 30 from the base station 20. The return channel 30 comprises a radio network controller (RNC) channel 32 and a first-in-first-out (FIFO) register 34 in which subsequent power control commands for different slots are successively stored. The return channel 30 may be any feedback radio channel which can be established towards the mobile terminal 10 e.g. by a radio network controller (RNC) controlling the base station 20.

The base station 20 comprises a receiving filter 22 for filtering the uplink signal transmitted by the mobile terminal 10 and supplying the filtered uplink signal to a WCDMA receiver 24, e.g. a Rake receiver comprising a collection of correlation receivers (fingers) in order to recover energy from several paths and/or antennas of a multipath propagation. Furthermore, a comparator functionality 26 is provided at the base station 20 for comparing a control value C derived from an SIR value measured at a WCDMA receiver 24 and a reference control value derived from an SIR target value tSIR supplied by an outer loop power control function provided at an RNC 40 serving the mobile terminal 10. The outer loop power control function is implemented by having the base station 20 tag each uplink user data frame with a frame reliability indicator RI, such as a Cyclic Redundancy Code (CRC) check result obtained at the WCDMA receiver 24 during decoding of the particular user data frame. Should the frame reliability indicator RI indicate to the RNC 40 that the transmission quality is decreasing, the RNC 40 in turn will command the base station 20 to increase the target SIR setpoint tSIR by a certain amount. Based on the result of comparison, the comparator 26 is arranged to output a transmitted power control command Ctx, e.g. “up” or “down”, supplied to the FIFO register 34 of the return channel 30.

In the RNC 40, a memory 42 is provided for storing a reference table comprising Eb/No reference control values which can be used e.g. as an initial SIR target value in uplink outer loop power control, for determining the NRT and RT load/power ratio used in admission control and packet scheduling, and for determining rate matching attributes. In the present case, the reference table is a two dimensional table, in which a bit rate BR and a target block error rate (BLER) tBLER are used for addressing the reference table. Additionally, coding could provide a third dimension to the table. Furthermore, the RNC 40 comprises an updating unit 44 for continuously or regularly updating the reference table based on the SIR targets tSIR derived from the outer loop power control, i.e. the frame reliability measurements at the base station 20. The updating unit 44 may be an RRM functionality provided at the RNC 40.

Furthermore, a network management system (NMS) 50 is connected to the RNC 40. The NMS 50 is a service function which employs a variety of tools, applications and devices to assist human network managers in monitoring and maintaining the network. It may comprise a set of functions required for controlling, planning, allocating, deploying, coordinating, and monitoring the resources of the network. In particular, QoS control capacity allocation and resource management policy is based on measurement data obtained from the network.

According to the first preferred embodiment, the reference control values stored in the reference table for the uplink transmission are updated using an autotuning algorithm. Initial values of the reference table may be obtained from simulations performed e.g. by the system supplier. As already mentioned above, the autotuning algorithm is based on the outer loop power control statistics. This means that the reference table is updated in an autotuning fashion based on the SIR target values tSIR given by the outer loop power control. In the system shown in FIG. 1, the autotuning algorithm is performed in the updating unit 44 of the RNC 40. The reference table may be arranged as a two dimensional matrix, wherein the Eb/No control values are either Eb/No values per antenna or MRC (Maximal Ratio Combining) combined SIR and Eb/No values combined over all receiving antennas provided at the base station 20. In the latter case, the MRC combined SIR is further divided at the base station 20 by the number of uplink antennas to obtain the Eb/No values per antenna.

For example, if MRC combined Eb/No is xdB and y antennas are used, then Eb/No per antenna is x-10 log₁₀(y) dB, e.g. if y=4, then Eb/No per antenna is about x-6 dB.

Preferably, the Eb/No per antenna should be used in all load calculations and power increase estimations, as this control value corresponds to the average Eb/No going over the air interface. It should be noted that throughout the present application, the expression “Eb/No” has the same meaning as “bit energy/(interference density+noise density)”.

If for some reason the outer loop power control SIR target values tSIR correspond to the combined SIR summed together from all receiving antennas of the base station 20, then uplink power increase estimator and uplink load factor should be calculated by using Eb/No control values where the number of uplink receiving antennas is taken into account. Thus, if an Eb/No control value is directly updated from outer loop values and there are four receiving antennas at the base station 20, then the Eb/No control value should be reduced by 6 dB in power increase estimation and determination of the uplink load factor and NRT load/power ratio.

The reference table is preferably arranged as a cell based table which differs cell by cell, due to the changed radio environments. Alternatively there could be one table for a cluster of similar cells (e.g. similar size and radio propagation environment). Using the proposed autotuning algorithm, the outer loop power control will provide statistics of Eb/No values for different bit rates, which can be used by the updating unit 44. The calculations for estimating and updating the reference table are then performed at the updating unit 44 and may then be transmitted as proposals to the NMS 50, where the operator either accepts or rejects the proposal of the autotuning algorithm.

As an alternative, the NMS 50 may perform the analysis or calculation of the Eb/No control values, in which case the RNC 40 transmits new outer loop power control Eb/No measurements or reliability indicators RI to the NMS 50.

In the following, examples for collecting outer loop statistics from the outer loop power control function are described. Outer loop statistics may only be collected from connections having one single radio access bearer per connection, i.e. one type of traffic or transmission path per connection, and having only one dedicated traffic channel and signalling channel. The outer loop statistics may be taken both when only the traffic channel is active and when both traffic and signalling channels are active. The reason therefore is that the Eb/No control values describe the average Eb/No control values of traffic channels and thus the Eb/No of the signalling channel should not dominate when outer loop Eb/No set point (i.e. SIR target) statistics are collected for traffic channels. The obtained samples may be averaged by using a pure mean filter over the connection and the averaged value is then provided to the autotuning algorithm at the updating unit 44 as the parameter Eb/No_conn(bit rate,BLERtarget).

FIG. 2 shows a basic flow diagram indicating corresponding steps of the autotuning algorithm or mechanism described above. In step S201, a new connection is selected e.g. from a concerned cell. Then, outer loop statistics obtained from the outer loop power control function of the selected connection are collected in step S202. A filter operation is then applied to the collected statistics e.g. for averaging samples of the collected outer loop statistics (step S203). Finally, in step S204, suggested update control values for those positions of the reference table corresponding to the bit rate and target block error rate of the selected connection are optionally suggested to the NMS 50 and used to update the reference table. It is noted that the optional suggestion function in step S204 may be provided for every connection or for a predetermined set or all connections at predetermined intervals. In the latter case, the signalling amount between the RNC 40 and the NMS 50 can be reduced.

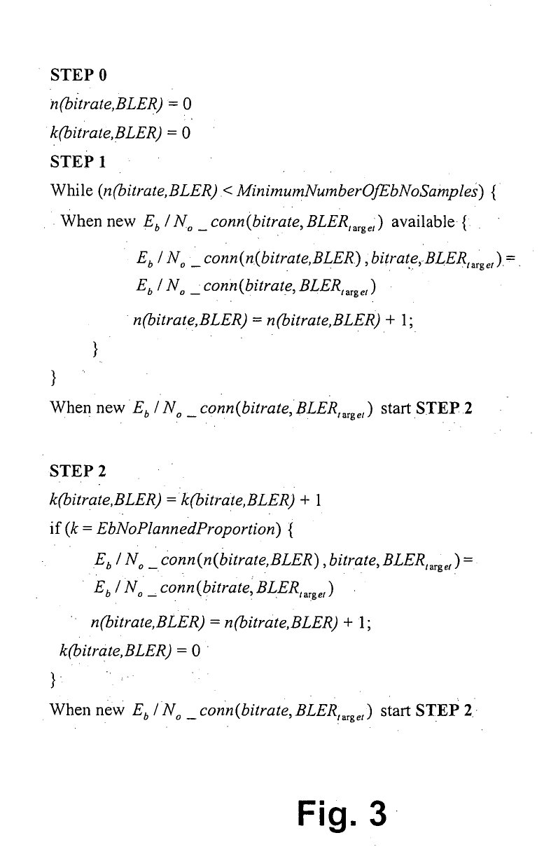

A sample generation procedure which may be used in step S202 or step S203 of FIG. 2 is described in connection with an algorithm shown in FIG. 3. According to this sample generation procedure, outer loop averaged SIR target values are collected from every N^{th} connection, e.g. every second sample in case N=2. In FIG. 3, N corresponds to the parameter Eb/NoPlannedProportion. The parameter Eb/NoPlannedProportion is the same for all bit rates BR and BLER targets tBLER used for addressing the reference table. As long as the total number of connections for a certain bit rate BR and BLER target tBLER is below a minimum threshold, all new samples are collected. In FIG. 3, the minimum threshold is indicated by the parameter MinimumNumberofEb/NoSamples.

In step 0 of FIG. 3, running variables n and k specified for every control value of the reference table are set to zero. Then, in step 1, a first loop is executed as long as the running variable n is smaller than the above threshold value defining the minimum number of the samples. During this first loop, all new samples are collected successively. When the running variable n has reached the threshold value, a second loop is executed in step 2, wherein the other running variable k is incremented and no sample value is collected until the other running variable k has reached the predetermined planned proportion value. Then, a single sample is collected and the first running variable n is incremented and the other running variable k is set to zero. Thereafter, step 2 is started again, when a new sample has been received. In the algorithm shown in FIG. 3, the parameter Eb/No_conn(n(bit rate, BLER), bit rate, BLER_{target}) denotes the n^{th} Eb/No-set point sample calculated from the SIR target when updating is done for a given bit rate and target BLER. The Eb/No set point has been averaged for the concerned connection by e.g. a simple mean filter in the outer loop power control. In the following, “n” will be used as a shortened term to denote “n(bit rate, BLER)”.

The mean filter may be based on a forgetting factor and may be described as follows:
E_{b}/N_{o—}planned(n,bitrate,BLER_{target})=β·E_{b}/N_{o—}conn(n,bitrate,BLER_{target})+(1−β)·E_{b}/N_{o—planned}(n−1,bitrate,BLER_{target})
where
E_{b}/N_{o—}planned(n,bitrate,BLER_{target}) is the E_{b}/N_{o—}Planned at n^{th} time when updating is done for given bit rate and target BLER. β is a small positive forgetting factor, e.g. β=0.01.

By adjusting the forgetting factor β, the speed of the autotuning algorithm can be changed. The larger the forgetting factor is the faster is the response the autotuning algorithm has for new measurements. On the other hand, if a quite conservative autotuning algorithm is desired, a small forgetting factor may be used.

As an alternative, a sliding window mean filter may be used. However, the reason why a mean filter with forgetting factor is chosen is that it requires little memory usage, as only the last mean value has to be stored in the corresponding memory.

It may be desirable to reduce the amount of changes in the reference table to those cases where the measurement samples of the outer loop power control lead to a substantial change in the control values of the reference table. To achieve this, a corresponding threshold value may be used.

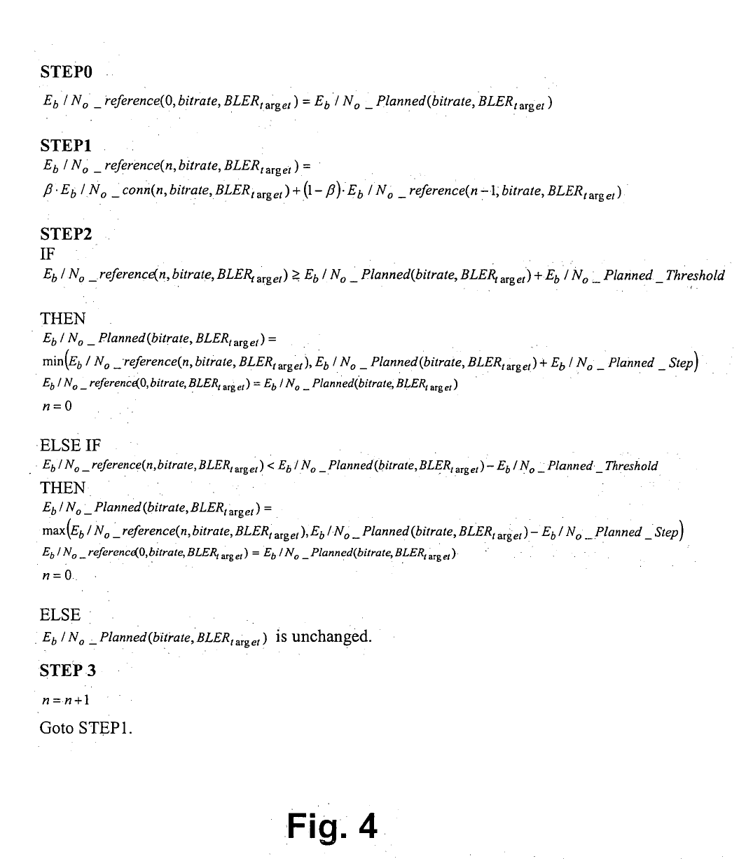

FIG. 4 shows an algorithm for implementing such a threshold based updating mechanism. In step 0, the initial filtered value Eb/NO_reference(0, bit rate, BLER_{target}) for a running variable n=0 is said to the previous control value at the corresponding location of the reference table. Then, in step 1, the filtering or averaging operation based on the forgetting factor β is executed to obtain a filtered value at the n^{th} instant after the previous updating of other control value. In step 2, it is checked whether the filtered value has changed to a sufficient extent defined by the parameter Eb/No_Planned_Threshold. If so, the control value is replaced by the new filtered control value as long as this new filtered control value is not larger than the highest possible step Eb/No_Planned Step defining how much the filtered control value can be changed at one round. If the change is larger than the biggest possible step, the previous control value is replaced by a new control value which is increased by the highest possible step. Then, the running variable n is set to 0.

If the filtered control value has decreased with respect to the previous control value, it is checked whether the amount of decrease is higher than the threshold. If so, the previous control value is replaced by the new decreased filtered control value as long as the highest possible step has not been surpassed. Otherwise, the previous control value is replaced by a new control value which is decreased by the highest possible step. Then, the running variable n is also set to 0. In both cases where the threshold has been increased or decreased by the required threshold, the initial filtered value is set to the updated new control value.

If the increase or decrease is below the required threshold, the previous control value remains unchanged.

In step 3, the running variable n is incremented and the procedure returns to step 1. In this respect, it is noted that the algorithm always starts from step 1 when a new measurement sample of a connection is provided.

If a sliding window mean filter is used instead of the mean filter with forgetting factor, the equation in step 1 of FIG. 4 can be replaced by the following equation:
STEP 1:

$${E}_{b} / {N}_{o} \_reference ( n , bitrate , {BLER}_{target} ) = \frac{1}{K} {\sum }_{i = 1}^{K} {E}_{b} / {N}_{o} \_conn ( n - i + 1 , bitrate , {BLER}_{target} ) ,$$

where K denotes the number of samples used in the averaging step, e.g. K=50.

Both alternative filtering or averaging algorithms can be implemented. In that case, a corresponding parameter may be provided for switching between these algorithms. For example if the parameter is set to a first value (e.g. 1), the mean filter operation with forgetting factor is used, and if the parameter is set to a second value (e.g. 2), the sliding window mean filter operation is used. As a default filter operation the mean filter operation with forgetting factor may be used. Furthermore, an additional parameter may be used for switching on or off the algorithm.

A soft handover functionality of the network can be taken into account as follows. On the one hand, soft handover connections may not be used in the updating of the Eb/No reference control values, or, on the other hand, the soft handover connections may also be used in the updating procedure. The usage may be controlled based on a parameter indicating whether soft handover connections are to be taken into account in the updating of the reference table, or not. This may be controlled by setting the parameter to the corresponding one of two values, e.g. 1 and 0. The default value for this parameter may be set to the value corresponding to a non-use of soft handover connections.

The general algorithm explained in connection with FIGS. 2 to 4 may be operated in two possible operating modes, which may be selected based on a corresponding mode setting parameter. Using this parameter, a fully automatic mode may be set, in which the algorithm will be automatically executed by itself without any interaction with an operator. Alternatively, a semi-automatic mode may be set, in which the autotuning algorithm suggests a change of the reference control values in the reference table, which has to be either accepted or rejected by the operator. If the operator rejects the change proposal, the algorithm may be adapted to reject only this particular change or to reject all changes relating to the corresponding bit rate and BLER target in that cell. This semi-automatic mode can be achieved by adding a binary parameter to the control values of the reference table, wherein the binary parameter indicates whether or not the corresponding element can be changed by the autotuning algorithm. Thus the acceptance or rejection of the proposed change can be controlled by setting the binary parameter to a corresponding value (e.g. 0 or 1).

The semi-automatic mode may be used as a default mode, wherein the fully automatic mode is used when experience indicates that the algorithm performs well to a sufficient extent in a semi-automatic mode.

In step S204 of the procedure shown in FIG. 2, the semi-automatic mode is indicated as an optional feature by the expression in brackets, which indicates that a change may optionally be suggested before the actual update of the referenced table.

As already indicated in FIG. 4, upper and lower boundaries may be provided for the allowable amount of change in the autotuning algorithm. In this case, the autotuning algorithm cannot be operated fully automatic beyond these values without operators acceptance. If those boundaries are reached, a message may be sent to the operator.

Another possibility for such control function may be to use a hypothesis testing when updating the reference control values. In this case, the reference table would only be updated if the difference between the current or suggested reference control values and the initial or old reference control values is statistically significant. This means that a reference control value is only changed if the error probability that the decision is wrong is below a predetermined threshold x %, e.g. x=1.

A feasible region for the tuning could be such that the minimum is half (−3 dB) of the initial reference control value and the maximum is double (+3 dB) of the initial reference control value. The checking operation can be performed at the NMS 50 e.g. based on a table indicating for each element of the reference table a ratio between the current or suggest reference control values and the initial reference control values.

The following tables 1 to 3 indicate initial reference control values (Eb/No ratios), current or suggested reference control values (Eb/No ratios), and ratios between the current and initial reference control values, respectively. The tables 1 to 3 are simplified in that only four reference control values are provided for bit rates 8 kbps and 64 kbps and BLER targets 0.01 and 0.1.

TABLE 1
Initial table

| | BLER-target = 0.01 | BLER-target = 0.10 |
|---|---|---|
| bitrate = 8 kbps | 6.8 dB | 5.4 dB |
| bitrate = 64 kbps | 4.2 dB | 3.0 dB |

TABLE 2
Current table from autotuning algorithm

| | BLER-target = 0.01 | BLER-target = 0.10 |
|---|---|---|
| bitrate = 8 kbps | 6.4 dB | 5.3 dB |
| bitrate = 64 kbps | 4.4 dB | 3.2 dB |

TABLE 3
Ratio between current and initial values

| | BLER-target = 0.01 | BLER-target = 0.10 |
|---|---|---|
| bitrate = 8 kbps | −0.4 dB | −0.1 dB |
| bitrate = 64 kbps | +0.2 dB | +0.2 dB |

Using the optimised Eb/No reference control values leads to improved uplink admission control and packet scheduling decisions, an improved initial uplink SIR target and an improved determination of static rate matching attributes. Thus the utilisation of the network capacity is improved. As an example, it is assumed that a load factor of a 12.2 kbps speech user is as follows:

$${L}_{user} = \frac{1}{1 + \frac{W}{R \cdot {E}_{b} / {N}_{0} \cdot υ}} = \frac{1}{1 + \frac{3840}{12.2` \cdot {10}^{6 / 10} \cdot 0.67}} = 0.0084$$

wherein the Eb/No reference control value was set to 6 dB. It is assumed that this value was correct. If to the value has been set to 12 dB, the load factor will be follows:

$${L}_{user} = \frac{1}{1 + \frac{W}{R \cdot {E}_{b} / {N}_{0} \cdot υ}} = \frac{1}{1 + \frac{3840}{12.2` \cdot {10}^{12 / 10} \cdot 0.67}} = 0.0326$$

which is about four times the correct value, i.e. 300% higher. On the other hand, if the reference control value is changed to 3 dB, the load factor changes as follows:

$${L}_{user} = \frac{1}{1 + \frac{W}{R \cdot {E}_{b} / {N}_{0} \cdot υ}} = \frac{1}{1 + \frac{3840}{12.2` \cdot {10}^{3 / 10} \cdot 0.67}} = 0.0042$$

which is about half of the correct load factor.

Thus, if wrong Eb/No reference control values are used wrong capacity is used in the uplink direction. This may lead to an overload situation or to a reduced coverage.

If the autotuning algorithm is performed in the RNC 40, the outer loop power control SIR targets have to be signalled to RNC 40. On the other hand, if the autotuning algorithm is performed in the NMS 50, an increased amount of signalling has to be performed between the RNC 40 and the NMS 50 for performing the update procedure. In case the outer loop power control function is arranged to be used for cells served by different RNCs the lur signalling, i.e. the signalling via the logical interface between the RNCs is not necessary for the autotuning function.

The control system may be enhanced in that different Eb/No reference tables given by the manufacturer or operator are used for uplink power increase estimation, NRT and RT load/power ratio estimation, rate matching etc., and the reference table given and updated by the autotuning algorithm will be used in the NMS 50 to analyse the radio environment of the cells.

Furthermore the outer loop power control SIR target may be the MRC combined SIR target overall uplink receiving antennas or the average SIR target value over the receiving antennas. The SIR target per antenna would be the easiest solution. However, if the combined SIR target value is used, the number of antennas in all base stations should be provided in order to calculate the SIR value per antenna as explained earlier.

As another issue, a biased reference table may be used in multivendor cases, where a biased SIR estimation is used in the base station of a specific vendor.

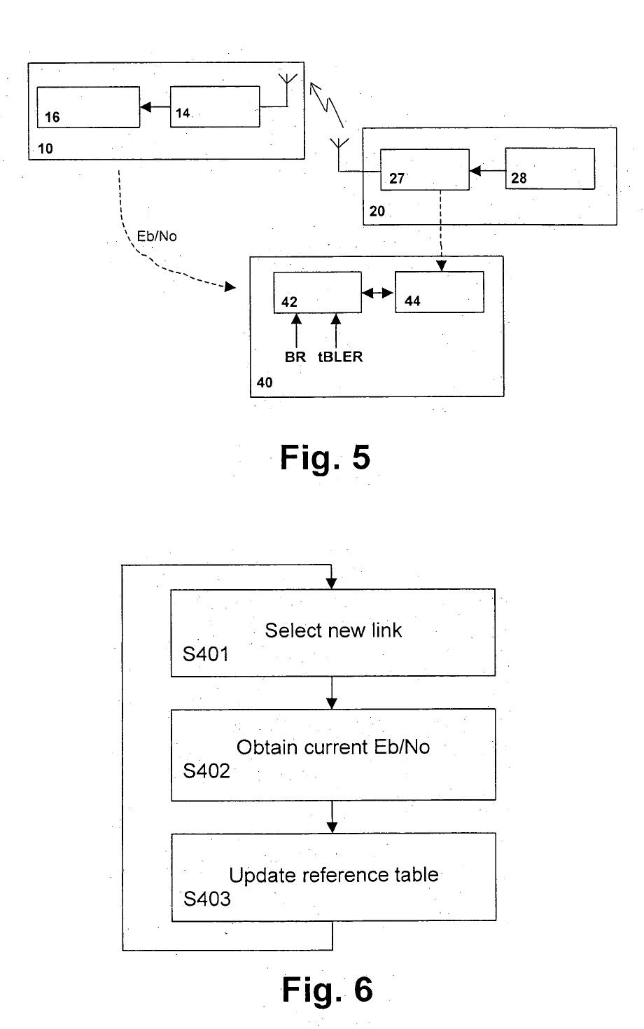

In the following, a second preferred embodiment for providing an autotuning function for a downlink transmission is described with reference to FIGS. 5 and 6.

FIG. 5 shows a schematic block diagram of a downlink transmission between the base station 20 and the mobile terminal 10. In the present case, a downlink reference table is stored in the memory 42 of the RNC 40. Again, the reference table is a 2-dimensional matrix addressed by the parameters bit rate BR and target BLER tBLER. The reference table is controlled or updated by the updating unit 44 similar to the first preferred embodiment. In the base station 20, a WCDMA transmitter 28 is provided for generating a WCDMA transmission signal to be supplied via the power amplifier 27 to a transmitting antenna.

At the terminal device 10, the transmission signal is received via a receiving antenna and supplied to a receiving filter 14 for providing a frequency selection function. From the receiving filter 14, the filtered signal is supplied to a WCDMA receiver e.g. a RAKE receiver 16.

In the second embodiment, the reference table or reference tables used in the downlink direction are autotuned based on measurements of a power control functionality, similar to the first preferred embodiment. However, in the downlink direction, the mobile terminal 10 usually does not report its measurement values. Therefore, an estimation function is provided, which periodically processes all or a subset of the downlink transmission links in the concerned sector or cell and estimates the current downlink Eb/Nos. Then, the entries of the downlink reference table of the RNC 40 are selected based on the service and bit rate of each link and are updated correspondingly e.g. adapted towards the estimated Eb/No of the concerned link.

FIG. 6 shows a schematic flow diagram indicating the basic steps of the above autotuning mechanism. In step S401 a new downlink transmitting link is selected. Then, the current Eb/No of the selected transmission link is obtained by the estimation function in S402. Based on the estimation result, the respective entry of the reference table is updated in step S403. The steps S401 to S403 are repeated until all or the subset of the downlink transmission links have been used for updating the table.

The estimation can be performed based on five information sources:
Ratio of link power to total power, orthogonality, and average own cell to other cell interference ratio
Pilot channel Ec/lo reports of the mobile station 10 and orthogonality
Uplink Eb/Nos
Retransmission requests
Eb/No reports of the mobile station 10.

In the following a specific procedure for estimating the reference control values in step S402 of FIG. 6 is described for a WCDMA system.

The downlink Eb/No value can be obtained based on the following equation:

$$Eb / No = \frac{G \cdot Ptx}{L \cdot I}$$

wherein G denotes the processing gain, i.e. the ratio of chip to bit rate, Pₜₓ denotes the transmission power to the mobile terminal 10, L (>1) denotes the path loss between the sector transmitter at the base station 20 and the mobile terminal 10, and I denotes the interference, i.e. the sum of own-cell interference, other-cell interference and thermal noise.

The method is periodically repeated for all or the subset of downlink transmitting links in the sector. For the computation of the processing gain, the bit rate is obtained from the downlink transport format of the radio access bearer. The link transmission power to the mobile terminal 10 is obtained as the average transmission power of a downlink Dedicated Channel maintained by the power control unit of the base station 20. The base station 20 reports the average transmission power periodically from the power control unit of the power amplifier 27 to the updating unit 44 of the RNC 40.

The product of path loss and interference used in the above equation can be estimated with two optional methods.

According to a first method, the product can be calculated as follows:

$$L \cdot I = L \cdot ( {I}_{own} + {I}_{oth} )$$

$$L \cdot ( \frac{{P}_{tot}}{L} \cdot ( 1 - α ) + \frac{{P}_{tot}}{L} \cdot i ) = {P}_{tot} \cdot ( 1 - α + i )$$

wherein Pₜₒₜ denotes the average total downlink transmission power, a denotes the average downlink orthogonality factor of the sector, and i denotes the average other-two-own cell interference ratio.

The base station 20 maintains the average total power and reports it periodically to the RNC 40. The orthogonality factor is an existing configuration parameter needed, for instance, in the calculation of the initial downlink link power. The average level of the other-two-own cell interference ratio i could be configured during the radio network planning phase. The values of α and i are not critical to the method because the downlink reference control values are mostly used in operations in which one reference control value is divided by another. The value of the term (1−α+i) is thus cancelled in such operations. The only exception is the initial downlink link power determination, in which case the tuned reference control value may not be applicable. Instead, the initially set reference control values obtained from the network planning phase may be used.

In a second method, information provided in the latest measurement report obtained from the mobile terminal 10 are used. Such a measurement report includes a ratio SIRₚᵢₗ which is the ratio of the received primary common pilot channel power Pₚᵢₗ to the interference density. The above product of path loss and interference is then obtained on the basis of the following equation:

$$L \cdot I = \frac{{P}_{pil}}{{SIR}_{pil}} - α \cdot {P}_{tot}$$

If the pilot measurements can be assumed accurate, this second method may be advantageous in that the obtained reference control values are more suitable for the determination of initial link powers.

The updating procedure may be based on a filtering or averaging operation by means of which the reference control value corresponding to the service and bit rate of the links terminal is slightly adapted towards the estimated reference control value of the link. As an example, a simple averaging filter operation may be provided based on the following equation:
Eb/No_{ref}=(1−β)Eb/NO_{ref}+βEb/Noₑₛₜ,
Wherein β denotes the forgetting factor, Eb/No_{ref} denotes the reference control value and Eb/Noₑₛₜ denotes the estimated reference control value. In the present case, β may be selected to a value close to zero, e.g. 0.01.

According to a third preferred embodiment, the downlink reference control values of NRT services and RT services with retransmissions, e.g. a streaming, interactive, and background services may be adapted according to the rate of retransmission requests. If the retransmission rate exceeds or is below the target BLER, the corresponding reference control value could be increased or decreased. Contrary to the above methods of the second preferred embodiment, this method is also applicable to an autotuning of the Downlink Shared Channel reference Eb/No.

According to a fourth preferred embodiment also used for autotuning in the downlink direction, downlink reference control values could be obtained from the corresponding uplink reference control values using a theoretically and empirically justified mapping function.

Finally, according to a fifth preferred embodiment, accuracy of the control could be improved by providing a reporting functionality by means of which the mobile terminal 10 can report the measured Eb/No values to the network, e.g. the RNC 40 or the NMS 50, as indicated by the dotted arrow in FIG. 5. The reported reference control values can then be used to autotune the referenced tables based on the bit rate and target BLER. To achieve this, a predetermined signalling or message header field could be provided.

It is noted that the present invention is not restricted to the specific features of the above preferred embodiments. The autotuning function may be used for any reference table provided for generating reference control values for a power and/or load control functions. Moreover, specific features of the above preferred embodiments may be combined in any way and are not restricted to each of the above embodiments. Also, the specific denotation of the parameters and network elements are not intended to restrict the present invention, but can be replaced by any corresponding element or parameter-having a similar function in other network architectures. Thus, the preferred embodiments may vary within the scope of the attached claims.

1-36. (canceled)

37. A method of controlling power and/or load in a network, said method comprising the steps of:
a) storing a reference table in said network;
b) using said reference table for deriving a reference control value from at least one connection-specific parameter;
c) performing said power and/or load control based on said reference control value;
d) estimating reference control values for said reference table based on a real measurement of at least one predetermined network parameter; and
e) updating said reference table using said estimated reference control values,
f) wherein said reference table is used for a downlink transmission, and wherein said estimating step comprises the steps of selecting a downlink transmission link, and calculating an estimation of said reference control value based on the following equation:
Eb/No=(G·Pₜₓ)/(L·I),
wherein G denotes the ratio of chip to bit rate, Pₜₓ denotes the transmission power to the corresponding terminal device, L denotes the path loss between the transmitter and said terminal device (L>1), and I denotes the sum of own-cell interference, other-cell interference and thermal noise.

38. A method according to claim 37, wherein said selecting and calculating step is performed periodically through at least a subset of all downlink transmission links in a predetermined sector.

39. A method according to claim 37, wherein the product L·I is calculated based on the following equation:
L·I=Pₜₒₜ·(1−α+i),
wherein Pₜₒₜ denotes the average total downlink transmission power reported by the network, a denotes the average downlink orthogonality factor, and i denotes the average other-to-own cell interference ratio.

40. A method according to claim 37 wherein the product L·I is calculated based on the following equation:
L·I=Pₚᵢₗ/SIRₚᵢₗ−α·Pₜₒₜ,
wherein SIRₚᵢₗ denotes the ratio of the received primary common pilot channel power Pₚᵢₗ to the interference density, as measured by the corresponding terminal device and reported to the network, α denotes the average downlink orthogonality factor, and Pₜₒₜ denotes the average total downlink transmission power reported by the network.

41. A method according to claim 37, further comprising a filtering step based on a forgetting factor for performing an adaptation towards said estimated reference control values, said forgetting factor defining scalar weights applied to said estimated reference control values.

42. A method according to claim 37, wherein said reference control value indicates a level of received bit energy to interference density which a receiver equipment requires for proper decoding of a received signal.

43. A method according to claim 37, wherein said real measurement comprises an outer loop power control measurement.

44. A method according to claim 37, wherein said at least one connection-specific parameter comprises a bit rate and/or target block error rate and/or coding of the connection.

45. A method of controlling power and/or load in a network, said method comprising the steps of:
g) storing a reference table in said network;
h) using said reference table for deriving a reference control value from at least one connection-specific parameter;
i) performing said power and/or load control based on said reference control value;
j) estimating reference control values for said reference table based on a real measurement of at least one predetermined network parameter;
k) updating said reference table using said estimated reference control values; and
l) transmitting said at least one estimated reference value to a network management function for deciding whether or not to update said reference table;
m) wherein said reference table is used for an uplink transmission; and
n) wherein said estimating step comprises the steps of selecting a connection, collecting outer loop power control statistics of said connection, and filtering said collected statistics.

46. A method according to claim 45, wherein said transmitting and deciding steps are performed in response to the value of a predetermined parameter.

47. A method according to claim 45, wherein said decision step is performed for all reference control values relating to the corresponding connection-specific parameter.

48. A method of controlling power and/or load in a network, said method comprising the steps of:
o) storing a reference table in said network;
p) using said reference table for deriving a reference control value from at least one connection-specific parameter;
q) performing said power and/or load control based on said reference control value;
r) estimating reference control values for said reference table based on a real measurement of at least one predetermined network parameter; and
s) updating said reference table using said estimated reference control values;
t) wherein said reference table is used for an uplink transmission;
u) wherein said estimating step comprises the steps of selecting a connection, collecting outer loop power control statistics of said connection, and filtering said collected statistics; and
v) wherein said collecting step is performed by collecting new samples as long as a certain one of said at least one predetermined network parameters is below a predetermined threshold.

49. A method of controlling power and/or load in a network, said method comprising the steps of:
w) storing a reference table in said network;
x) using said reference table for deriving a reference control value from at least one connection-specific parameter;
y) performing said power and/or load control based on said reference control value;
z) estimating reference control values for said reference table based on a real measurement of at least one predetermined network parameter;
aa) updating said reference table using said estimated reference control values; and
bb) using a forgetting factor in said filtering step, said forgetting factor defining scalar weights applied to said estimated reference control values;
cc) wherein said reference table is used for an uplink transmission; and
dd) wherein said estimating step comprises the steps of selecting a connection, collecting outer loop power control statistics of said connection, and filtering said collected statistics.

50. A method according to claim 49, wherein said forgetting factor is adjusted to change the speed of said updating step.

51. A method according to claim 49, further comprising the step of storing only the last filtered value for use in a subsequent filter operation.

52. A method according to claim 45, wherein said estimating step further comprises the step of collecting samples of said filtered statistics.

53. A method according to claim 45, wherein said filtered statistics comprise SIR values.

54. A method according to claim 45, wherein said collected statistics are averaged in said filtering step.

55. A method according to claim 45, wherein said reference control value is estimated per antenna.

56. A method according to claim 45, wherein said reference control value is estimated by combining reference control values over a plurality of antennas.

57. A method according to claim 45, wherein said reference table is a cell-based table.

58. A method according to claim 45, wherein said reference table is a cell-cluster based table.

59. A method according to claim 45, further comprising the step of performing said table update when said at least one predetermined network parameter has changed by a value higher than a predetermined threshold value.

60. A method according to claim 45, wherein said filtering step is performed by using a sliding window filter operation.

61. A method according to claim 60, further comprising the step of providing a parameter for switching between said sliding window filter operation and a filter operation based on a forgetting factor.

62. A method according to claim 45, further comprising the step of providing a parameter for defining whether or not soft handover connections are used in said updating step.

63. A method according to claim 45, further comprising the step of providing upper and/or lower limit values for said updating step.

64. A method according to claim 63, further comprising the step of activating an indication function if said upper or lower limit value is reached during said updating step.

65. A method according to claim 45, further comprising the step of inhibiting said updating step based on the result of a hypothesis testing.

66. A method according to claim 45, wherein said estimation step is performed at a network management function.

67. A method according to claim 45, wherein said outer loop power control statistics are collected from connections having a single radio access bearer per connection.

68. A network element for controlling power and/or load in a network, said network element comprising:
ee) storing means for storing a reference table used for deriving a reference control value from at least one connection-specific parameter;
ff) control means for performing said power and/or load control based on said reference control value;
gg) estimating means for estimating reference control values for said reference table based on a real measurement of at least one predetermined network parameter; and
hh) updating means for updating said reference table using said estimated reference control values,
ii) wherein said reference table is used for a downlink transmission, and wherein said estimating step comprises the steps of selecting a downlink transmission link, and calculating an estimation of said reference control value based on the following equation:
Eb/No=(G·Pₜₓ)/(L·I),
wherein G denotes the ratio of chip to bit rate, Pₜₓ denotes the transmission power to the corresponding terminal device, L denotes the path loss between the transmitter and said terminal device (L>1), and I denotes the sum of own-cell interference, other-cell interference and thermal noise.

69. A network element according to claim 68, further comprising filtering means for applying a filter operation to said estimated reference control values.

70. A network element according to claim 69, wherein said filter operation is based on a sliding window or a forgetting factor.

71. A network element according to claim 68, wherein said network element is a radio network controller.

72. A network element according to claim 68, wherein said network element comprises a network management system.
